(19) United States
(12) Patent Application Publication
(10) Pub. No.: US 2010/0088478 A1
(43) Pub. Date: Apr. 8, 2010

(54) System for Internally Monitoring an Integrated Circuit

(75) Inventors: Mark Brian Carson, Belfast (GB); David William McCracken, Jordanstown (GB); James Paul Crossey, Belfast (GB)

Correspondence Address: SMITH MOORE LEATHERWOOD LLP, P.O. BOX 21927, GREENSBORO, NC, 27420, US

(73) Assignee: Omiino Limited, Belfast (GB)

(21) Appl. No.: 12/574,032

(22) Filed: Oct. 6, 2009

(30) Foreign Application Priority Data
Oct. 6, 2008 (GB) 0818239.6

(51) Int. Cl. G06F 12/00; G06F 3/14

(52) U.S. Cl. 711/154; 715/700; 711/E12.001

(57) ABSTRACT

A system for internally monitoring an integrated circuit, wherein the contents of memory locations in the integrated circuit can be displayed on a dedicated display unit via a graphical interface device provided in the integrated circuit. The system provides a built-in means for observing the internal state of both firmware and hardware (as applicable) on the integrated circuit device. This facilitates the development of, and ongoing health monitoring of, the device in any system into which it may be incorporated. The provision of a graphical interface device provides a relatively high bandwidth for the outgoing data and so allows the internal state of the device to be monitored in real time.

### CROSS-REFERENCE TO RELATED APPLICATIONS

This application claims priority to United Kingdom Application No. 0818239.6, filed Oct. 6, 2008, all of which is incorporated by its entirety.

### FIELD OF THE INVENTION

The present invention relates to a system for internally monitoring an integrated circuit, especially an Application Specific Integrated Circuit (ASIC) or a Field Programmable Gate Array (FPGA).

### BACKGROUND TO THE INVENTION

Conventionally, an integrated circuit device, such as an ASIC or FPGA, may include a host interface to enable it to communicate with an external controlling device, which may include, or be connected to, a computer, typically a PC. The controlling device supports a development user interface and driver software that allow a user access to data registers within the device. This in turn enables the user to monitor the state of the device during development or testing.

However, the access provided to the user is considered to be restricted and generally requires the presence of the external controlling device. It would be desirable therefore to provide a system that allows greater access and control to the user.

### SUMMARY OF THE INVENTION

A first aspect of the invention provides an integrated circuit device comprising processing circuitry for performing a primary task, said processing circuitry including at least one data storage device providing a plurality of data storage locations in which, in use, data concerning said primary task is stored, the device further including a host interface device by which access to said data storage locations from externally of the integrated circuit device is provided, wherein said integrated circuit device further includes a graphical interface device by which data retrieved from said data locations during use may be communicated to an external display unit, said graphical interface device including means for generating signals from said retrieved data that are capable of driving said external display unit to display said retrieved data.

Typically, said integrated circuit device includes an internal data processor arranged to retrieve data from said data storage locations in response to an instruction received via said host interface, or other source. Said graphical interface device conveniently includes a memory device for storing data to be displayed on said external display unit. In preferred embodiments, said internal processor is arranged to retrieve data from one or more of said data locations and to cause said retrieved data to be stored in said memory device. The internal processor typically includes means for converting the retrieved data into a format that is suitable for display on said external display unit.

In some embodiments, a command interface device is provided in said integrated circuit device to provide communication between said internal processor and an external computer.

A second aspect of the device provides a system for internally monitoring an integrated circuit, the system comprising the integrated circuit device of the first aspect of the invention; a dedicated display device connected to said integrated circuit device via said graphical interface device; and an external computer connected to said integrated circuit device via said host interface device or, when present, said command interface device, said external computer supporting an application for allowing a user to send commands to said internal processor concerning monitoring and/or configuring said data storage locations.

In preferred embodiments, said integrated circuit device is adapted to process traffic signals from a communications network and so includes at least one input for receiving traffic signals, or a part thereof, and at least one output for forwarding traffic signals, or a part thereof.

Advantageously, the system provides a built-in means for observing the internal state of both firmware and hardware (as applicable) on the integrated circuit device. This facilitates the development of, and ongoing health monitoring of, the device in any system into which it may be incorporated. Significantly, the provision of a graphical interface device that allows retrieved data to be sent to a dedicated display unit provides a relatively high bandwidth for the outgoing data and so allows the internal state of the device to be monitored in real time.

The invention is particularly applicable for use with Field Programmable Gate Arrays (FPGA) and Application Specific Integrated Circuits (ASIC). However, the invention may be used with any integrated circuit device, or logic device, whether programmable or not.

Preferred embodiments provide a dedicated communications link from the integrated circuit device to a dedicated data display unit and, preferably also, a dedicated communications link to said external computer. The external computer typically supports a development user interface, usually comprising application software that allows a user to communicate with the internal processor.

This means that the development interface does not need to be supported by the external controlling device, or the device driver software which runs on said external controlling device. The data display unit provides monitoring of status changes within the integrated circuit device. The development user interface controls the data display unit, and allows configuration of the integrated circuit device. In typical embodiments, the data display unit is provided separately from the development user interface.

Further advantageous aspects of the invention will become apparent to those ordinarily skilled in the art upon review of the following description of specific embodiments of the invention.

### BRIEF DESCRIPTION OF THE DRAWINGS

Specific embodiments of the invention are now described by way of example and with reference to the accompanying drawings in which like numerals are used to indicate like parts and in which:

FIG. 1 is a schematic view of a system for internally monitoring an integrated circuit, being a first embodiment the invention;

FIG. 2 is a schematic view of a system for internally monitoring an integrated circuit, being a second embodiment of the invention;

FIG. 3 is a schematic view of a system for internally monitoring an integrated circuit, being a third embodiment of the invention; and

FIG. 4 is a schematic view of a system for internally monitoring an integrated circuit, being a fourth embodiment of the invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

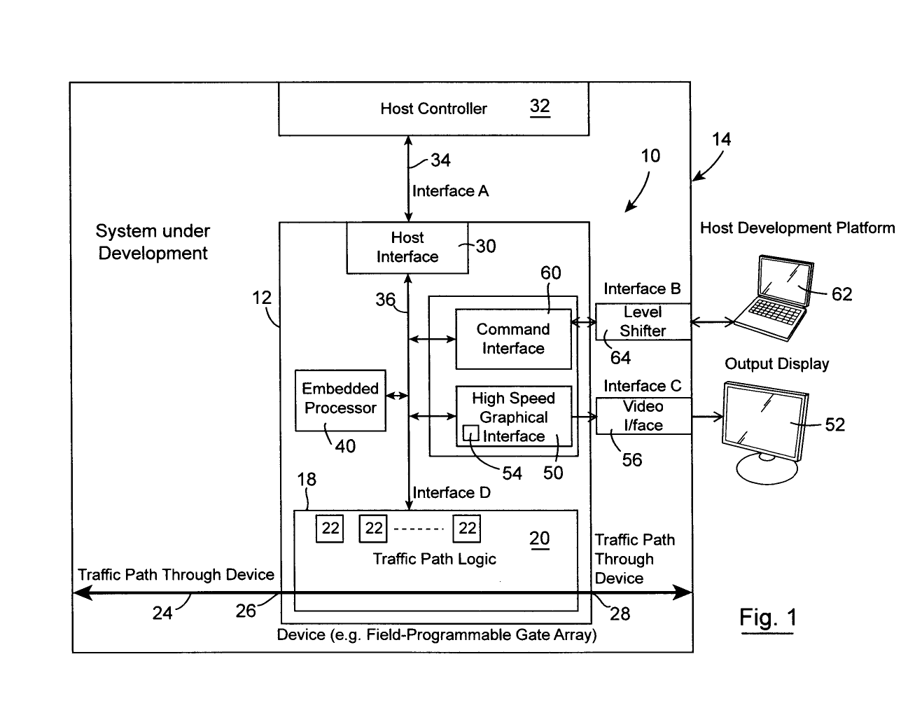

Referring now to FIG. 1 of the drawings there is shown, generally indicated as 14, a system board including a monitoring system 10 embodying the invention. The system 10 enables a target device 12 to be monitored and configured. This facilitates debugging and testing of the device 12. In the drawings, the target device 12 comprises an integrated circuit in the form of an FPGA, although the target device may alternatively comprise any other integrated circuit, especially an ASIC. More generally, the target device 12 may comprise one or more integrated circuits or logic devices, which may be programmable or non-programmable. The target device 12 is shown incorporated into the system board 14. The system board 14 may comprise a development board, or any other assembly board, comprising one or more other components (not shown) that facilitate the operation, programming, testing and/or debugging of the device 12 as applicable.

The device 12 includes processing circuitry 18 adapted to perform one or more functions in accordance with the intended purpose of the device 12. The processing circuitry 18 typically includes logic circuitry 20 and a plurality of data storage devices 22, most commonly in the form of data registers and/or data memories, e.g. RAMs.

In preferred embodiments, the processing circuitry 18 is adapted to process data traffic signals 24 of a data communications network (not shown), such as an optical network (e.g. SDH or SONET), IP (Internet protocol) network or other telecommunications network. Hence, in the illustrated embodiment, the device 12 includes a traffic input 26 and traffic output 28 (although each of these may serve as both an input and an output), the processing circuitry 18 being capable of performing one or more processing functions on, or in relation to, the traffic signals, and/or the signal path associated with the traffic signals. These processing functions may include data monitoring, retrieval and/or configuration functions. For example, the traffic signals are commonly comprised of a header (or overhead) portion and an associated payload portion, the header/overhead carrying information pertaining to the associated payload and/or the signal path, and the circuitry 18 is adapted to process the header/overhead data.

Typically, the circuitry 18 includes a bus (not shown) and plurality of data storage devices 22 (for example data registers and RAMs) connected to the bus. The storage devices 22 are used in the control and/or monitoring the operation of the traffic data and/or signal path.

The device 12 normally includes a host interface device 30 by which a host controller 32, or other external control device, is able to communicate with the device 12. An external communications link 34, for example a Motorola power QUICC link or other address/data bus, is provided for communicating data between the host controller 32 and the device 12. An internal communications link 36, for example a Xilinx on-chip peripheral bus, or other address/data bus, is provided for communicating data between the processing circuitry 18 and the interface device 30, the interface device 30 being adapted to facilitate communication between the communication links 34, 36 either directly or indirectly. In simple embodiments, the interface device 30 converts a bi-directional data bus (34) into separate read/write buses (36) within the device 12.

The host controller 32, which is external to the device 12, typically comprises a microprocessor and may be used (and appropriately programmed) to provide configuration or performance monitoring of the device 12, and more particularly of the data storage devices 22, via the communication links 34, 36 and interface device 30.

To support communication between the device 12 and the host controller 32, at least one, and typically a plurality of, I/O pins (not shown) of the device 12 are used for communicating data signals between the host interface device 30 and the host controller 32. These pins, which are normally considered to form part of the interface device 30, may be said to comprise a first I/O port of the device 12. Typically, the first I/O port is configured as a parallel port.

In the embodiment of FIG. 1, the device 12 includes an embedded data processor 40, e.g. microprocessor or microcontroller, and is programmable to provide one or more control functions within the device 12. Where the device 12 includes configurable resources (e.g. in an FPGA), the processor 40 may take the form of a “soft core” device implemented using the configurable resources of the device 12. Alternatively, the processor 40 may take the form of a “hard core” that is incorporated into the device 12. Normally, the processor 40 is programmed to control and/or configure the processing circuitry 18 and to control communications between the processing circuitry 18 and the external controller 32.

The internal communication link 36 is typically also used to provide communication between the embedded processor 40 and interface device 30, and between the embedded processor 40 and the processing circuitry 18.

Conventionally, a user (not shown) may perform monitoring and/or configuration of the processing circuitry 18, and more particularly of the data storage devices 22 by means of the host controller 32, the communication links 34, 36 and the host interface device 30 and, when present, the embedded processor 40. However, the bandwidth offered by this arrangement is relatively low and this restricts the operations that can be performed and the information that can be returned to the host controller 32.

To address this problem, and in accordance with at least some aspects of the invention, the device 12 is provided with a graphical interface device 50, which may alternatively be referred to as a graphical display driver. The graphical interface device 50 comprises means for generating, from data to be displayed, signals that are capable of driving a video display unit 52. The graphical interface device 50 may be arranged to generate signals that are compatible with any desired video interface standard, for example, VGA (Video Graphics Array) or Digital Video Interface (DVI), or a custom interface specification. The interface device 50 typically comprises electronic hardware and may be substantially conventional in design. A data memory 54, typically in the form of a RAM, is provided for storing the data to be displayed. The data memory 54 may be provided as part of the graphical interface device, or may be separate from but accessible by the graphical interface device 50.

In use, the embedded processor 40 writes data to be displayed into the memory 54 whereupon the graphical interface device 50 generates corresponding video signals and causes these to be transmitted to the display unit 52. To this end, in the embodiment of FIG. 1, the graphical interface device 50 is connected to the communications bus 36 for communication with the embedded processor 40.

To support communication between the device 12 and the display unit 52, at least one, and typically a plurality of, I/O pins (not shown) of the device 12 are used for communicating data signals from the graphical interface device 50 to the display unit 52. These pins, which may be considered to form part of the interface device 50, may be said to comprise a second output port of the device 12. Typically, the second port is configured as a parallel port and is unidirectional in that it carries video signals, usually including video data and synchronisation signals, that are sent from the graphical interface device 50 to the video display unit 52. The second port is considered to provide a high speed interface, supporting data rates typically of approximately 50 Mbit (pixels) per second.

Advantageously, because the graphical interface device 50 is able to support a relatively high speed link from the device 12 to the display unit 52, data from the device 12 can be displayed on the display unit 52 in real time and this allows a user to observe real time events that could not otherwise be observed if, for example, the data were sent to the host controller 32 via the host interface device 30.

The display unit 52 provides a dedicated display for data retrieved from the device 12. Conveniently, the display unit 52 need only have the capability to support the display of alphanumerical characters and optionally some basic graphical characters, for example for drawing lines and/or boxes.

A video signal interface unit 56 may be provided for adapting video signals from the device 12 into a format suitable for driving the video display 52. Typically, this involves adjusting, usually reducing, the voltage level of the output video signals. For example, in the case where the device 12 is an ASIC or FPGA and the signals are intended to be VGA compatible, the unit 56 reduces the voltage of the Red, Green and Blue video signals emanating from the graphical interface device 50 from typically 3.3V to approximately 1V. The video signal interface unit 56 may for example be incorporated into a communications cable (not shown) connecting, in use, the device 12 and the display unit 52.

In preferred embodiments, the device 12 is provided with a command interface device 60 for enabling communication between a second external computer 62, hereinafter referred to as the host development platform, and the device 12, in particular the embedded processor 40 and optionally the data storage devices 22.

The host development platform 62 comprises an external computer system supporting application software, typically in the form of a development user interface, that allows a user to perform monitoring and/or configuration operations in relation to the device 12, including debugging operations. The command interface device 60 is arranged to receive command signals from the host development platform 62 and communicate these to the embedded processor 40. For example, the command signals may relate to the retrieval of data from the data storage devices 22 and the display of said data on the display unit 52, or the configuration of data storage devices 22 with data received from the host development platform 62. The interface device 60 typically comprises electronic hardware and may be substantially conventional in design. The interface device 60 typically supports a bi-directional communications link to allow acknowledgement of commands and the uploading of data to the host development platform 62.

In use, the embedded processor 40 receives commands from the command interface device 60 whereupon it takes appropriate action in relation to the data storage devices 22, e.g., retrieval and/or setting of data values. To this end, in the embodiment of FIG. 1, the command interface device 60 is connected to the communications bus 36 for communication with the embedded processor 40.

To support communication between the device 12 and the host development platform 62, at least one, and typically a plurality of, I/O pins (not shown) of the device 12 are used for communicating data signals from the command interface device 60 to the host development platform 62. These pins, which may be considered to form part of the interface device 60, may be said to comprise a third I/O port of the device 12. Typically, the third port is configured as a serial port and is bi-directional. For example, the serial port may have separate receive and transmit links, and may operate at typically between approximately 9600 and 115200 bits per second.

A command signal interface unit 64 is provided for adapting signals sent between the device 12 and the host development platform 62. Typically, this involves adjusting the voltage level of the output communications signals. For example, in the case where the command interface device 60 supports an RS-232 communications link between the device 12 and the platform 62, the command signal interface unit 64 is arranged to convert the relatively low (e.g. approximately 3.3V) voltage signals output by the device 12 to the +/−9V levels required on the RS-232 link. The command signal interface unit 64 may for example be incorporated into a communications cable (not shown) connecting, in use, the device 12 and the platform 62.

The processor 40 executes, in use, computer program code that is stored, typically in a ROM, or other memory (not shown) and is accessible by the processor 40. It will be understood that references to the processor 40 made herein are intended to include its programming. The processor 40 may be provided in the device 12 for conventional reasons, e.g. processing data held in the storage devices 22, configuring the circuitry 20 and communicating with the host controller 32 via the host interface 30, and may be programmed accordingly. In such cases, additional programming is provided to cause the processor 40 to perform the additional tasks required to support the present invention, for example receiving commands from the host development platform 62 and writing data retrieved from the data storage devices 22 to the memory 54 of the graphical interface device 50. The additional programming may be implemented in any convenient manner, typically by means of suitably programmed ROM or other firmware.

It will be seen from the foregoing that the device 12 supports a plurality of separate interfaces with the external environment, namely a communication interface (labelled as Interface A in FIG. 1) between the device 12 and the external host controller 32 to allow conventional status and control operations using the registers 22; a communications, or command, interface (labelled as Interface B in FIG. 1) between the device 12 and the host development platform 62; and a dedicated video interface (labelled as interface C in FIG. 1) from the device 12 to the display device 52.

By way of example, in use, the user may send a command from the host development platform 62 to the embedded processor 40 via the command interface 60 requesting that the contents of certain registers 22 be displayed on the display unit 52. When the processor 40 retrieves the requested data, it stores it in the memory 54 whereupon the graphical interface device 50 generates a corresponding video signal that is used to drive the display unit 52. Because the bandwidth supported by the graphical interface device 50 is relatively high, real-time monitoring of events within the device 12 can be performed. The command interface device 60 and graphical interface device 50 are also capable of supporting other monitoring, configuration, testing and debugging operations.

Advantageously, the host development platform 62 supports a multi-screen option whereby a graphical user interface displayed by the display device of the platform 62 offers the user a choice of several different views of the device 12, each view comprising a respective set of data obtained from the data storage devices 22. For example, the different views may relate respectively to path overhead status, traffic alarms, path alarms, or any other topic of interest. When the user selects which view he wishes to see, the platform 62 sends an appropriate command to the processor 40 which retrieves the relevant information and writes it to the memory 54 whereupon it is sent to the display unit 52 by the graphical interface device. The contents of the memory 54 may be written over each time a different view is selected and so there is no need for the data for each view to be gathered until it is requested.

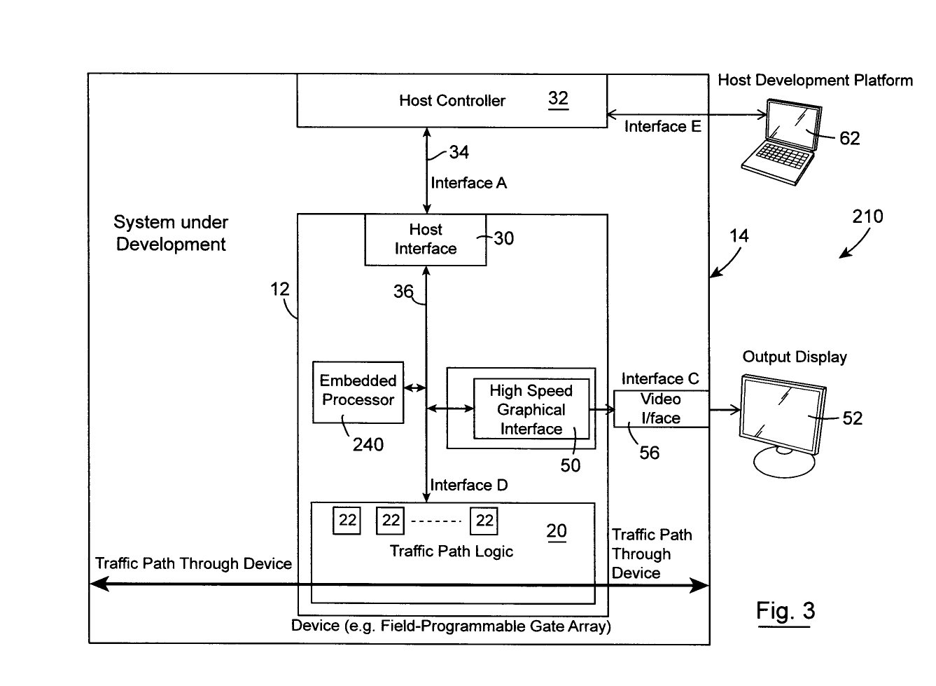

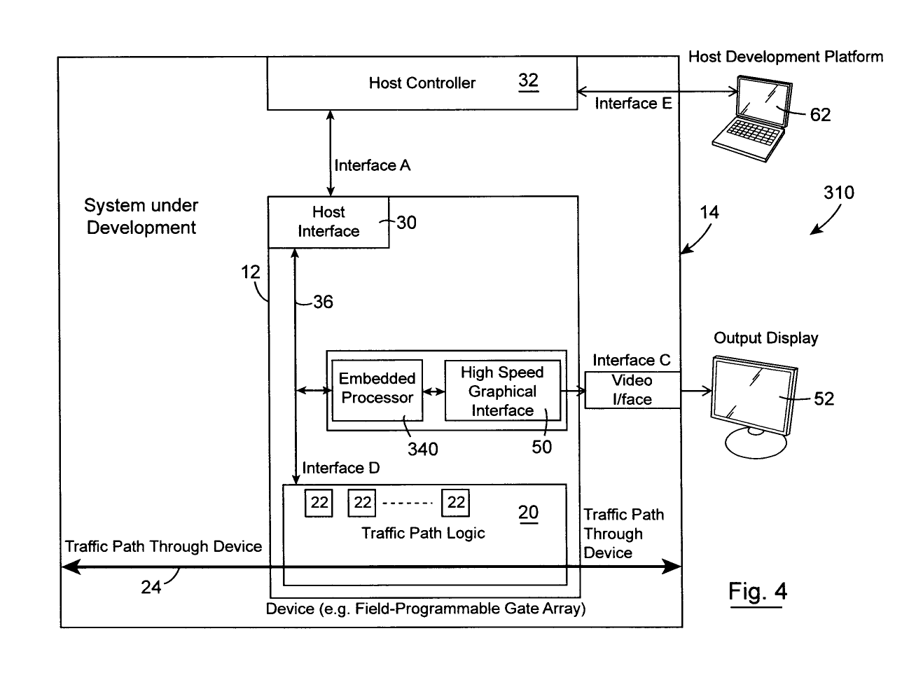

To accommodate situations where the dedicated display unit 52 is not available, e.g. during field use of the board 14 rather than during development or testing, the host development platform 62 and the processor 40 are arranged to support a data capture mode whereby a command is sent from the platform 62 to the processor 40 in response to which the processor 40 causes the contents of the memory 54 of the graphical interface device 50 to be sent to the host development platform 62 for display on its own display device. In the embodiment of FIG. 1, the captured data is sent to the platform 62 via the command Interface B, but it may alternatively be sent via Interface A, as will be apparent from considering the embodiments of FIGS. 3 and 4 below.

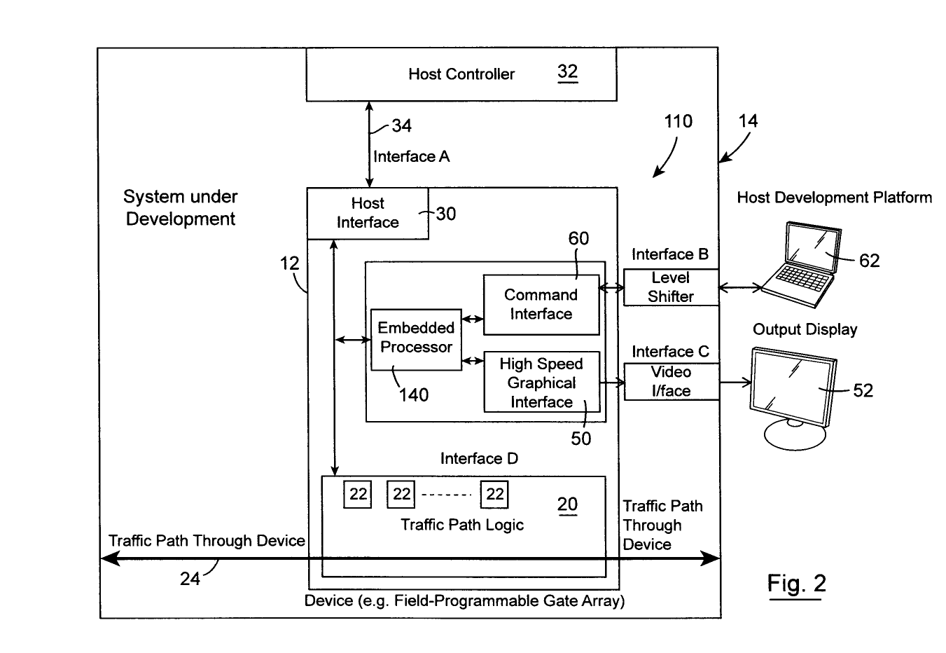

An alternative embodiment is shown in FIG. 2 in which the monitoring system 110 is substantially similar to the system 10 except that the embedded processor 140 is dedicated to working with the command interface device 60 and graphical interface device 50 in the manner described above. In this embodiment, it is assumed that the device 12 does not have its own embedded processor for performing conventional debugging and monitoring tasks via the host interface device 30 and so the dedicated processor 140 is provided for purposes of the invention. In the embodiment of FIG. 2, the command interface device 60 and graphical interface device 50 each communicate directly with the embedded processor 140, the embedded processor 140 communicating with the data storage devices 22 via the bus 36.

A further alternative embodiment is shown in FIG. 3 in which the monitoring system 210 is substantially similar to the system 10 except that the command interface device and associated components are omitted, or at least not used. In this embodiment, the host development platform 62 communicates with the processor 240 via the host controller 32. The processor 240 is programmed to receive commands from the host development platform 62 via the host interface device 30 and, in response, to write the retrieved data to the memory 54. The embodiment of FIG. 3 can allow the host development platform 62 to be located remotely from the device 12 since it does not have to be connected directly to it.

FIG. 4 shows a still further embodiment in which the monitoring system 310 is substantially similar to the system 210 except that the embedded processor 340 is dedicated to working with the graphical interface device 50 in the manner described above.

It will be apparent from the foregoing that preferred embodiments of the invention allow real-time monitoring of internal firmware and hardware state. Data retrieved from the device 12 may be presented as a plurality of pages on a standard VDU screen or the like. There is a capability of presenting hundreds of pieces of independent information in real-time.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. An integrated circuit device comprising:
processing circuitry for performing a primary task, said processing circuitry including at least one data storage device providing a plurality of data storage locations in which, in use, data concerning said primary task is stored,
a host interface device by which access to said data storage locations from externally of the integrated circuit device is provided, and
a graphical interface device by which data retrieved from said data locations during use may be communicated to an external display unit, said graphical interface device including means for generating signals from said retrieved data that are capable of driving said external display unit to display said retrieved data.

2. An integrated circuit device as claimed in claim 1, further including an internal data processor arranged to retrieve data from said data storage locations.

3. An integrated circuit device as claimed in claim 1, wherein said graphical interface device includes a memory device for storing data to be displayed on said external display unit.

4. An integrated circuit device as claimed in claim 3, further including an internal data processor arranged to retrieve data from said data storage locations and wherein said internal processor is arranged to retrieve data from one or more of said data locations and to cause said retrieved data to be stored in said memory device.

5. An integrated circuit device as claimed in claim 2, wherein the internal processor includes means for converting said retrieved data into a format that is suitable for display on said external display unit.

6. An integrated circuit device as claimed in claim 2, further including a command interface device to provide communication between said internal processor and an external computer.

7. An integrated circuit device as claimed in claim 1, configured to process traffic signals from a communications network, the integrated circuit device including at least one input for receiving traffic signals, or a part thereof, and at least one output for forwarding traffic signals, or a part thereof.

8. An integrated circuit device as claimed in claim 1, wherein the integrated circuit device comprises at least one Field Programmable Gate Array (FPGA).

9. An integrated circuit device as claimed in claim 1, wherein the integrated circuit device comprises at least one Application Specific Integrated Circuit (ASIC).

10. An integrated circuit device as claimed in claim 1, comprising a first port by which said host interface is capable of communicating with an external device and a second port by which said graphical interface device is capable of communicating with said external display unit.

11. An integrated circuit device as claimed in claim 6, further including a third port by which said command interface device is capable of communicating with said external computer.

12. An integrated circuit device as claimed in claim 1, further including an internal data processor arranged to retrieve data from said data storage locations; and an internal data communications link between said host interface device and said data storage locations, wherein said graphical interface device and said internal data processor are each connected to said data communications link.

13. An integrated circuit device as claimed in claim 12, further including a command interface device to provide communication between said internal processor and an external computer, and wherein said command interface device is connected to said internal data communications link.

14. An integrated circuit device as claimed in claim 1, further including an internal data processor arranged to retrieve data from said data storage locations; and an internal data communications link between said host interface device and said data storage locations, wherein said internal data processor is connected to said data communications link and wherein said graphical interface device is in direct communication with said internal data processor.

15. An integrated circuit device as claimed in claim 14, further including a command interface device to provide communication between said internal processor and an external computer, and wherein said command interface device is in direct communication with said internal data processor.

16. An integrated circuit device as claimed in claim 3, wherein, in a second mode of use, data stored in said memory device is communicated to an external device via said host interface device for display on said external device.

17. An integrated circuit device as claimed in claim 1, arranged to support a dedicated video interface for enabling communication between said graphical display device and said external display unit, and at least one of a host interface and a command interface, said integrated circuit device being arranged to receive commands relating to the contents of said data storage locations by at least one of said at least one of a host interface and a command interface.

18. A system for internally monitoring an integrated circuit, the system comprising an integrated circuit device and a dedicated display unit, said integrated circuit device comprising:
processing circuitry for performing a primary task, said processing circuitry including at least one data storage device providing a plurality of data storage locations in which, in use, data concerning said primary task is stored,
a host interface device by which access to said data storage locations from externally of the integrated circuit device is provided, and
a graphical interface device by which data retrieved from said data locations during use may be communicated to said dedicated display unit, said graphical interface device including means for generating signals from said retrieved data that are capable of driving said dedicated display unit to display said retrieved data,
said dedicated display device being connected to said integrated circuit device via said graphical interface device.

19. A system as claimed in claim 18, further including an external computer connected to said integrated circuit device via said host interface device or, when present, a command interface device, said external computer supporting an application for allowing a user to send commands to said internal processor concerning monitoring and/or configuring said data storage locations.

20. A system as claimed in claim 18, further including a video signal interface unit connected between said graphical interface device and said dedicated display unit.

21. A system as claimed in claim 18, further including a host controller connected to said integrated circuit device via said host interface device.

22. A system as claimed in claim 21, comprising a first dedicated video communications link between said integrated circuit device and said dedicated display unit, and at least one other communications link between said integrated circuit device and at least one other device that is external to the integrated circuit device.

23. A system as claimed in claim 22, wherein said at least one other communications link includes a communications link between said host interface device and a host controller, the host controller being external to said integrated circuit device.

24. A system as claimed in claim 22, wherein said at least one other communications link includes a communications link between a command interface device and a computer, said computer being external to said integrated circuit device.
